(19) United States
(12) Patent Application Publication
(10) Pub. No.: US 2020/0378015 A1
(43) Pub. Date: Dec. 3, 2020

(54) ELECTROCHEMICAL PRODUCTION OF A GAS COMPRISING CO WITH INTERMEDIATE COOLING OF THE ELECTROLYTE FLOW

(71) Applicant: Siemens Aktiengesellschaft, Munich (DE)

(72) Inventors: Marc Hanebuth, Nurnberg (DE); Günter Schmid, Hemhofen (DE); Dan Taroata, Erlangen (DE); Clara Delhomme-Neudecker, München (DE); Benjamin Hentschel, München (DE); Andreas Peschel, Wolfratshausen (DE); Nicole Schödel, München (DE)

(73) Assignee: Siemens Aktiengesellschaft, Munich (DE)

(21) Appl. No.: 16/964,750

(22) PCT Filed: Jan. 18, 2019
(86) PCT No.: PCT/EP2019/051254

§ 371 Date: Jul. 24, 2020

(30) Foreign Application Priority Data
Feb. 15, 2018 (DE) 10 2018 202 337.9

(51) Int. Cl. C25B 1/00; C25B 11/02; C25B 9/08; C25B 9/20; C25B 15/08

(52) U.S. Cl. CPC C25B 1/00; C25B 11/02; C01B 32/50; C25B 9/206; C25B 15/08; C25B 9/08

(57) ABSTRACT

A method for the electrochemical production of a gas including CO, in particular CO or syngas, from CO₂, wherein the electrochemical production of the gas including CO, in particular CO or syngas, from CO₂ takes place in multiple electrolytic cells, which are arranged in series one behind the other in the direction of at least one electrolyte flow and each include a cathode and an anode, wherein the at least one electrolyte flow is conducted through the electrolytic cells which are arranged in series one behind the other and is intermediately cooled between at least two electrolytic cells which are arranged in series one behind the other. A device is adapted for carrying out the method.

### CROSS REFERENCE TO RELATED APPLICATIONS

This application is the US National Stage of International Application No. PCT/EP2019/051254 filed 18 Jan. 2019, and claims the benefit thereof. The International Application claims the benefit of German Application No. DE 10 2018 202 337.9 filed 15 Feb. 2018. All of the applications are incorporated by reference herein in their entirety.

### FIELD OF INVENTION

The present invention relates to a method for the electrochemical production of a gas comprising CO, in particular CO or syngas, from CO₂, wherein the electrochemical production of the gas comprising CO, in particular CO or syngas, from CO₂ takes place in multiple electrolytic cells which are arranged in series one behind the other in the direction of at least one electrolyte flow and each comprise a cathode and an anode, wherein the at least one electrolyte flow is conducted through the electrolytic cells which are arranged in series one behind the other and is intercooled between at least two electrolytic cells which are arranged in series one behind the other, and a device for carrying out the method.

### BACKGROUND OF INVENTION

At present, CO is produced by means of various methods, for example together with H₂ steam reforming of natural gas or by gasification of various types of feedstock such as coal, petroleum or natural gas and subsequent purification.

CO can also be synthesized electrochemically from CO₂. This is, for example, possible in high-temperature (HT) electrolysis (SOEC, solid oxide electrolysis cell). Herein, for example, 02 forms on the anode side and CO on the cathode side in accordance with the following reaction formula: CO₂→CO+½O₂.

The mode of operation of high-temperature electrolysis and possible processor concepts are, for example, described in WO 2014154253, WO 2013131778 WO 2015014527 and EP 2940773 A1. Here, high-temperature electrolysis is mentioned together with possible CO₂/CO separation by means of absorption, adsorption, a membrane or cryogenic separation. However, the precise embodiment and possible combinations of the separation concepts are not disclosed.

High-temperature electrolysis can also be operated with H₂O and CO₂ as feed which can be used for the electrochemical production of syngas (mixture of CO and H₂). This then entails co-electrolysis (here ‘co’ relates to the use of two feeds, water and CO₂). For clear designation, hereinafter, the following terms are used: HT CO₂-electrolysis (high-temperature electrolysis with CO as the product) and HT co-electrolysis (high-temperature electrolysis with syngas as the product). When only HT electrolysis is mentioned, both variants are meant.

The electrochemical production of CO from CO₂ is also possible with low-temperature (LT) electrolysis, for example with aqueous electrolytes, as described in Delacourt et al. 2008 (DOI 10.1149/1.2801871). Here, the following reactions take place for example:

Cathode: CO₂+2e⁻+H₂O→CO+2OH⁻;

Anode: H₂O→½O₂+2H⁺+2e⁻.

Herein a proton (H⁺) can, for example, migrate through a proton exchange membrane (PEM) from the anode to the cathode side.

In some cases, hydrogen also forms on the cathode: 2H₂O+2e⁻+→H₂+2OH⁻.

Depending on the structure of the electrolytic cell, cations other than protons (for example K⁺), which are contained in the electrolyte, can be conducted through a membrane for charge exchange, as described in Delacourt et al. 2008 (DOT 10.1.149/1.2801871). A so-called anion exchange membrane (AEM) can also be used depending on the structure. The reaction equations can then be formulated accordingly depending on, for example, an ion exchange and the pH of an electrolyte. Here, preferably a cathode catalyst and an anode catalyst can be printed directly on the corresponding membrane. This embodiment is similar to the usual PEM concept in H₂O to H₂ electrolysis.

Similarly to the case with HT electrolysis, either CO or syngas can be primarily produced. In order again to use clear terminology, hereinafter, the following terms are used: LT CO₂ electrolysis (low-temperature electrolysis with CO as the product, wherein small amounts of H₂ can also be produced as a by-product) and LT co-electrolysis (low-temperature electrolysis with syngas as the product). If only LT electrolysis is mentioned, both variants are meant.

Depending on the use of a suitable catalyst, other valuable products such as ethylene, ethanol, etc. can be formed in electrolysis. An overview of the mode of operation and possible reactions are, for example, set forth in WO 2016124300 A1, WO 2016128323 A1 and Kortelever et al. 2012 (DOI 10.1021/acs.jpclett.5b01559)

LT electrolysis operation under increased pressure is also found, for example, in Dufek et al. 2012 (DOI 10.1149/2.011209jes). This describes advantages with respect to efficiency and the current strengths to be achieved. There is no discussion of gas losses of CO₂, CO and H₂ in the O₂ flow.

The separation concepts for the LT CO₂ electrolysis in principle correspond to the above-mentioned concepts for the separation of product gases in HT electrolysis, for example HT CO₂ electrolysis. However, LT electrolysis can be operated at a higher pressure than HT electrolysis. With a high pressure level in electrolysis of, for example, 10 bar and more, in particular 20 bar or more, the product gas does not necessarily have to be compressed before separation of the products in order to obtain a substantially pure product for further processing, whereby savings can be made on energy and equipment.

The efficiency of electrolysis is frequently between 40% and 80%. This results in a significant amount of waste heat, which is normally dissipated via the electrolyte circuit. To perform electrolysis as efficiently as possible, it is expedient to limit the temperature increase in the electrolytic cell to a few kelvin. However, this leads to a relatively high electrolyte flow.

A typical LT CO₂ electrolysis setup in an exemplary electrolyzer E from the prior art with (viewed from below) a gas space, a cathode, a cathode space with a catholyte K, a membrane (hatched), an anode space with an anolyte A, and an anode is depicted schematically in FIG. 1.

In the setup in FIG. 1 a CO₂ feed flow lake-up) is combined with a recycled CO₂ flow 5 (recycle) and forms the CO₂ feed 2 (feed) to the electrolytic cell. This can optionally also be moistened with water. Via a suitable electrode, for example a gas diffusion electrode (GDE), CO₂ reaches the catalyst for the electrochemical reaction, for example silver, and is converted to CO. In addition, hydrogen may also form as a by-product. The raw product flow 3, which, in addition to CO, may also contain H₂ as a by-product, unconverted CO₂ and H₂O, is separated in a downstream process in order to form a product flow 4, substantially containing CO, and the recycled CO₂ flow 5 with unconverted CO₂. In addition, a catholyte feed flow 6 is fed in on the cathode side (in the figure adjacent to the cathode), and an anolyte feed flow 7 is fed in on the anode side. By way of example, the anolyte in FIG. 1 comprises KOH. The membrane (depicted by hatching), for example an ion-exchange membrane (for example Nation) or a porous membrane, can ensure that the charge carriers are exchanged and that no mixing of the anode gas (gas present and/or formed at the anode side) and gas from the catholyte occurs. The anode reaction results in an increase in the 02 content in the anolyte so that the emerging anolyte flow 9 is subject to gas-liquid separation in order to remove the oxygen from the electrolyte circuit again. Moreover, as a result of the contact between the catholyte and the gas channel H₂, CO and CO₂ enter the catholyte. In order to avoid a difference in the concentrations between the anolyte and the catholyte, and also the electrolyte flows 8 and 9 depicted here by way of example, the gas-laden electrolyte flows in LT electrolysis are frequently combined as shown in FIG. 1 by way of example. The combined electrolyte flow 10, which here is gas-laden, is subject to gas-liquid separation, wherein here CO₂, CO, H₂ and O₂ can escape as gases, for example via a so-called oxygen vent. This produces a gas flow 11 and a liquid electrolyte flow 12 to be recycled. The liquid electrolyte flow 12 is optionally cooled in order to remove the waste heat from the electrolytic cell (not shown) and a make-up flow 13 is usually necessary to compensate electrolyte losses and establish a suitable electrolyte concentration again. The electrolyte flow feed 14 established in this way is then again divided into a catholyte feed flow 6 and an anolyte feed flow 7.

However, it has been observed that, via the gas diffusion electrode in the electrolytic cell, CO₂, CO and H₂ dissolve in the electrolyte and can be lost in significant amounts with the O₂ in the gas flow 11. This makes the operation of LT electrolysis under increased pressure, for example at an excess pressure of more than 500 mbar, uneconomical. Neither is separation of the gas flow 11 to recover CO₂, CO and/or H₂ economical.

### SUMMARY OF INVENTION

It is therefore an object of the present invention to provide a method and a corresponding device which enable a significant reduction of CO₂, CO and H₂ losses in the O₂ flow during CO₂ electrolysis.

The inventors have found that intercooling of the electrolyte can reduce the amount of electrolyte circulating during electrolysis and reduce gas losses during electrolysis. Lowering the temperature can increase the amount of dissolved CO₂, although, surprisingly, the amount of gases lost does not increase to the same degree and thus the amount of electrolyte circulating can be reduced.

In a first aspect, the present invention relates to a method for the electrochemical production of a gas comprising CO, in particular CO or syngas, from CO₂, wherein the electrochemical production of the gas comprising CO, in particular CO or syngas, from CO₂ takes place in multiple electrolytic cells which are arranged in series one behind the other in the direction of at least one electrolyte flow and each comprise a cathode and an anode, wherein the at least one electrolyte flow is conducted through the electrolytic cells which are arranged in series one behind the other and is intercooled between at least two electrolytic cells which are arranged in series one behind the other.

Also disclosed is a device for the electrochemical production of a gas comprising CO, in particular CO or syngas, from CO₂, comprising—multiple electrolytic cells which are arranged one behind the other in particular in the direction of at least one electrolyte flow and each comprise a cathode and an anode; —at least one connecting facility between at least two electrolytic cells, which is embodied to conduct the at least one electrolyte flow between the at least two electrolytic cells; and—at least one first feed facility for a first starting material flow comprising CO₂, which is embodied to feed the first starting material flow comprising CO₂ to the first electrolytic cell arranged in the direction of flow of the CO₂; further comprising at least one intercooler, which is embodied to cool at least one electrolyte flow of the at least one connecting facility.

Further aspects of the present invention are set forth in the dependent claims and the detailed description.

### BRIEF DESCRIPTION OF THE DRAWINGS

The attached drawings are intended to illustrate and provide further understanding of embodiments of the present invention. In conjunction with the description, they serve to explain concepts and principles of the invention. Other embodiments and many of the advantages cited arise with respect to the drawings. The elements of the drawings are not necessarily drawn to scale with respect to one another. The same, functionally identical and identically acting elements, features and components in the figures of the drawings are given the same reference numbers unless stated otherwise.

FIG. 1 is a schematic depiction of a concept of a CO₂ electrolyzer from the prior art with a common electrolyte circuit, CO₂ separation and recycling.

FIG. 2 and FIG. 3 are each schematic depictions of an embodiment of the present invention. Herein, the reference numbers are the same as those in FIG. 1.

### DETAILED DESCRIPTION OF THE INVENTION

Unless it is defined otherwise, the technical and scientific terms used herein have the same meaning as is commonly understood by a person skilled in the field of the invention.

Quantities in the context of the present invention relate to wt %, unless stated otherwise or evident from the context.

Gas diffusion electrodes (GDE) generally are electrodes in which liquid, solid and gaseous phases are present and where in particular a conductive catalyst can catalyze an electrochemical reaction between the liquid and the gaseous phase.

They can be embodied in different ways, for example as a porous “solid material catalyst” possibly with auxiliary layers for adjusting hydrophobicity; or as conductive porous carriers on which a catalyst can be applied in a thin layer.

In the context of the invention, syngas is a gas mixture substantially comprising hydrogen and carbon monoxide. Herein, the volume ratio of H₂ to CO is not particularly limited and can, for example, be within a range of 10:1 to 1:10, for example 5:1 to 1:5, for example 3:1 to 1:3, wherein however, it is also possible for other suitable ratios to be established with regard to further use.

A stack or cell stack is an interconnection of multiple electrolytic cells, for example 2 to 1000, for example 10-200, advantageously 25-100 electrolytic cells or cells from the perspective of an applied voltage in a series connection.

The present invention is described in the following in respect of intercooling between electrolytic cells which are arranged in series one behind the other in the direction of at least one electrolyte flow. Here, it is irrelevant whether the individual electrolytic cells are in the same stack or are in different stacks (i.e. in the direction of the at least one electrolyte flow in the last cell of a stack and the first cell of a subsequent stack). In particular, in the method according to the invention and the device according to the invention, the intercooling takes place between at least two stacks, advantageously between all stacks, of the device, wherein however the possibility is not excluded of intercooling also taking place between electrolytic cells within a stack. In this respect, the following description relates generally to intercooling between two electrolytic cells which are arranged in series one behind the other in the direction of at least one electrolyte flow regardless of whether they are in the same stack and/or different stacks.

The normal pressure is 101325 Pa=1.01325 bar.

In a first aspect, the present invention relates to a method for the electrochemical production of a gas comprising CO, in particular CO or syngas, from CO₂, wherein the electrochemical production of the gas comprising CO, in particular CO or syngas, from CO₂ takes place in multiple electrolytic cells which are arranged in series one behind the other in the direction of at least one electrolyte flow and each comprise a cathode and an anode, wherein the at least one electrolyte flow is conducted through the electrolytic cells which are arranged in series one behind the other and is intercooled between at least two electrolytic cells which are arranged in series one behind the other.

Since the method according to the invention can in particular be performed with the device according to the invention, due to the complexity of the device and for easier understanding, the basic setup of the device according to the invention is also disclosed with the method according to the invention. However, advantageous embodiments of the device according to the invention are also discussed following the method according to the invention in connection with the device aspect of the present invention.

The electrochemical production of the gas comprising CO, in particular CO or syngas, from CO₂ is not particularly limited according to the invention. According to certain embodiments, the electrochemical production takes place in low-temperature electrolysis, advantageously at elevated pressure. In particular, LT electrolysis can be operated at elevated pressure without losing significant amounts of product and/or starting material from the cathode side, for example H₂, CO, and/or CO₂. Advantageously, the method is performed such that in the individual electrolytic cells of a device, the electrolysis in each case takes place at substantially the same temperature, for example 15 to 150° C., advantageously 30° C. to 100° C., particularly advantageously 60° C. to 80° C., and/or the same pressure, for example ambient pressure to 1000 kPa (10 bar) excess pressure, advantageously ambient pressure to 500 kPa (5 bar) excess pressure, particularly advantageously ambient pressure to 50 kPa (0.5 bar) excess pressure.

In the method according to the invention and i.e. with the device according to the invention, multiple electrolytic cells, i.e. at least two, advantageously however multiple, i.e. for example 3, 4, 5, 6, 7, 8, 9, 10 or more, advantageously 5 to 500, further advantageously 10-200, for example 25-100, electrolytic cells are arranged one behind the other such that the electrolyte passes through all the electrolytic cells in series. Accordingly, the electrolytic cells can form a cell stack or stack comprising the individual cells. As already stated above, there is at least intercooling between at least two cell stacks, in particular between all cell stacks.

Herein, the individual electrolytic cells in each case comprise a cathode and an anode, but are not further limited beyond this. They can contain one or more separators, for example membranes and/or diaphragms, for example between an anode space and a cathode space. In addition, the electrolytic cells comprise at least one power source, wherein the power can also be provided from renewable energies, for example.

Moreover, the electrolytic cells in each case comprise at least one feed for a starting material flow comprising CO₂, which is advantageously guided to the cathode and correspondingly represents a feed for a cathode starting material comprising CO₂, wherein this can originate from the preceding electrolytic cell in the direction of flow of the starting material, from a common source of starting material for multiple cells or all cells, or a separate source, so that, for example, it is also possible for two or more electrolytic cells to be supplied with CO₂-containing starting material from a variety of sources. The embodiment of the corresponding feed facilities for these cases will be further clarified in the following.

In addition, advantageously each electrolytic cell in each case contains a discharge facility for the product of the cathode of the respective electrolytic cell, advantageously in gaseous form. Alternatively, the gas spaces of multiple electrolytic cells can be connected via product connecting facilities.

Moreover, each electrolytic cell comprises at least one electrolyte feed facility and one electrolyte discharge facility. Herein, the first of the electrolytic cells arranged one behind the other in the direction of flow of the electrolyte comprises at least one feed facility for the electrolyte, which can be connected to at least one reservoir and/or one recycling facility for the electrolyte, wherein the possibility is not excluded of the electrolyte having two feed facilities as a feed facility for the anolyte and a feed facility for the catholyte if the feeding of the catholyte to the cathode space and of the anolyte to the anode space take place separately.

Herein, the catholyte and the anolyte can originate from a common reservoir and/or a recycling facility for the electrolyte or from separate reservoirs and/or recycling facilities for the electrolyte, wherein the reservoirs for the electrolyte can also be at least partially filled from recycling facilities for the electrolyte. According to certain embodiments, at least one recycling facility for the electrolyte is present even if electrolyte recycling does not mandatory have to be present in the method and the device according to the invention.

Moreover, the device according to the invention is provided with at least one last electrolyte discharge facility, which adjoins the last electrolytic cell in the direction of flow of the electrolyte and can also be connected to at least one recycling facility for the electrolyte, wherein the possibility is not excluded of the electrolyte discharge having two last discharge facilities as a last discharge facility for the anolyte and last discharge facility for the catholyte if the discharge of the catholyte from the cathode space of the last electrolytic cell in the direction of flow of the electrolyte and of the anolyte from the anode space of last electrolytic cell in the direction of flow of the electrolyte take place separately.

The feed and discharge facilities for the electrolyte lying between the individual electrolytic cells in the direction of flow of the electrolyte are in each case connected to at least one connecting facility so that at least one connecting facility (for the electrolyte) is provided between the discharge facility for the electrolyte of an electrolytic cell which is not the last electrolytic cell in the direction of flow of the electrolyte and the feed facility for the electrolyte of an adjoining electrolytic cell (which is consequently not the first electrolytic cell in the direction of flow of the electrolyte).

Thus, if more than two electrolytic cells are present in the device according to the invention, this results in at least two connecting facilities (for the electrolyte). Here, if in each case only one connecting facility is present between two electrolytic cells, the number of connecting facilities (for the electrolyte) is hence one less than the number of electrolytic cells in the device according to the invention and also in the method according to the invention.

However, if the electrolyte in the electrolytic cells is in each case separated into an anolyte and a catholyte, advantageously in each case discharge facilities and feed facilities are also present for the catholyte and the anolyte and accordingly it is also advantageous for the respective connecting facility to be embodied separately as a first connecting facility and as a second connecting facility, wherein the at least one first connecting facility is embodied to conduct a catholyte flow and the at least one second connecting facility is embodied to conduct an anolyte flow. Accordingly, according to certain embodiments, the at least one electrolyte flow between the multiple electrolytic cells which are arranged in series one behind the other is advantageously separated into a catholyte flow and an anolyte flow.

Although it is obviously also conceivable for one or two connecting facilities (for the electrolyte) to be variably provided between different electrolytic cells and one or two feed and/or discharge facilities (for the electrolyte) to be variably provided at the respective electrolytic cells, this is not advantageous since this could result in the products of the electrolysis being mixed and this can have a negative impact on those in the adjoining electrolytic cell.

According to certain embodiments, after discharge from the last electrolytic cell in the direction of flow of the electrolyte, an anolyte flow and a catholyte flow, if both are present, are combined and jointly returned via a common recycling facility for the electrolyte in order to enable differences in concentration between catholyte and anolyte to be compensated again. Here, the catholyte flow and the anolyte flow or the combined electrolyte flow can be suitably purified of product gases contained therein, for example also anodically produced product gases such as oxygen, and/or starting material gases before they are returned again and/or provided for another use. If the electrolyte in a combined electrolyte flow is recycled, before re-entering the first electrolytic cell, in the method according to the invention, possibly after the addition of a ma up electrolyte flow, it can be separated again into an anolyte flow and a catholyte flow.

Since an electrolyte can usually be lost in the method according to the invention moreover it is also additionally possible for one or more additional (make-up) electrolyte flow(s) to be fed to the one or more reservoirs—for example two—and/or the one or more—for example two—recycling facilities for the electrolyte in order to compensate the losses, so that accordingly it also possible for one or more, for example one, electrolyte-make-up feed facility(ies) to be present in the device according to the invention.

At least one starting material comprising CO₂ and at least one electrolyte flow through the multiple electrolytic cells provided. Thus, at least one starting material flow comprising CO₂ and one electrolyte flow are present in the respective electrolytic cells. These can be guided parallel to one another through the respective electrolytic cell—i.e. with the same direction of flow, and/or in opposite directions and/or in the cross flow, wherein the directions of flow in the individual cells can be the same or vary. Here, with regard to the electrolyte flow and the starting material flow comprising CO₂, or with regard to a catholyte flow, an anolyte flow and/or the starting material flow comprising CO₂—if the electrolyte flow is divided into a catholyte flow and an anolyte flow—the current can be conducted in the same or opposite directions or in the cross flow and is not particularly limited in individual electrolytic cells or in stacks or also in comparison with stacks. For example, the anolyte flow and the catholyte flow can be conducted in the same direction to one another and in the opposite direction to the starting material flow comprising CO₂ for easier separation of gas bubbles in the electrolyte. According to certain embodiments, in the respective electrolytic cells, the starting material flow comprising CO₂ and the electrolyte flow run in the same direction or in opposite directions.

If a starting material flow comprising CO₂ is conducted as a starting material flow through multiple or all of the electrolytic cells one after the other, this starting material flow can also be conducted parallel to the electrolyte flow or in the counter direction, i.e. in the opposite direction.

In the method according to the invention, the electrolyte flow passes independently of the starting material flow comprising CO₂ through multiple electrolytic cells arranged one behind the other in series, i.e. multiple electrolytic cells, wherein it changes in composition from one electrolytic cell to the other as a result of the electrochemical conversion and/or the transition from starting material and/or product gas. The intercooling enables this change to be minimized, in particular with regard to the transition of gases, whether they be starting materials and/or products. The fact that the electrolyte flow passes in series through different electrolytic cells in terms of both time and space results in a series arrangement or an in-line arrangement, as is the case with corresponding reactor arrangements in chemical synthesis, wherein, however, here, in contrast thereto advantageously the same product, CO or syngas, is obtained in each electrolytic cell, at least on the cathode side.

If moreover the starting material flow comprising CO₂ is conducted through all electrolytic cells through which the electrolyte flow is also guided, moreover a first feed facility is provided for the starting material flow comprising CO₂. If multiple starting material flows, for example a first and a second starting material flow comprising CO₂, are fed to multiple, for example two, electrolytic cells in parallel, for example from a common source for the starting material flows or from different sources, at least one first and one second feed facility for a first and a second starting material flow comprising CO₂ are provided in a device according to the invention.

In addition, further components of usual electrolytic cells, which are not particularly limited, can be present in the electrolytic cells.

The different feed facilities, discharge facilities and connecting facilities for the starting material flow comprising CO₂ (wherein here connecting facilities for the starting material flow comprising CO₂ do not necessarily have be present for each electrolytic cell if some cells, for example in different stacks, or each cell, are or is in each case loaded with a separate starting material flow comprising CO₂, as described above by way of example) are not particularly limited with regard to their dimensions, embodiment and material and can, for example, be embodied as tubes and/or lines. According to certain embodiments, a separate feed of the starting material flow comprising CO₂ goes to different stacks, in particular to the first electrolytic cell in the direction of flow of the starting material flow in the stack in each case, in particular to all stacks of a device according to the invention, in a method according to the invention, and accordingly a device according to the invention, comprising multiple, i.e. at least 2, 3, 4, 5, 6, 7, 8, 9, 10 or more, stacks accordingly also advantageously comprises at least one second, third, fourth, fifth, sixth, seventh, eighth, ninth, tenth or more feed facility for a second, third, fourth, fifth, sixth, seventh, eighth, ninth, tenth or more starting material flow comprising CO₂, advantageously to the electrolytic cells lying in each case in the direction of flow of the starting material flow in the stack.

According to certain embodiments, in at least one electrolytic cell, advantageously in at least two electrolytic cells, for example all electrolytic cells arranged one behind the other in a device according to the invention, the cathode is embodied as a gas diffusion electrode (GDE). Here, the respective GDE can then be in contact with a “gas space” on one side via which the CO₂ is fed to the electrolytic cell.

If multiple gas spaces are present in multiple electrolytic cells, these can, for example, be connected via gas connecting facilities so that a cathode starting material flow comprising CO₂ is further transported from a first electrolytic cell into the further electrolytic cells, possibly then also with products of the electrolysis such as CO.

Alternatively, it is also possible for the respective gas spaces to be again supplied with a “fresh” starting material flow so that at least two, for example each, electrolytic cell and/or two, for example each, stack of the device according to the invention has its own feed facility for the cathode starting material comprising CO₂, wherein here, according to certain embodiments, the individual gas spaces are not connected and the product gas obtained can be discharged as a product flow from each gas space on the cathode side. The corresponding product flows can then be combined to form a common product gas flow before the product gas can then be fed to a separating facility where unconverted starting material can then be separated and recycled in order to form a new feed for one or more electrolytic cells of the device according to the invention.

According to certain embodiments, when the cathode starting material is fed separately, it is provided from a common source, which is not particularly limited, wherein CO₂ can, for example, originate from a combustion reaction of, for example, waste, coal, etc. Before being fed to the electrolytic cells in the method according to the invention or into the electrolytic cells of the device according to the invention, the CO₂ can possibly also be moistened.

In the method according to the invention, a starting material comprising CO₂ is converted to a gas comprising CO, for example CO or syngas, i.e. a mixture comprising CO and H₂. Herein, however, the possibility is not excluded of further gases being contained in the starting material, such as, for example, also CO. Advantageously, the starting material for the cathode contains at least 20 vol % CO₂, further advantageously at least 50 vol % CO₂, yet further advantageously at least 80 vol % CO₂, in particular advantageously at least 90 vol % CO₂, based on the starting material for the cathode, for example 95 vol % or more or 99 vol % or more CO₂.

Similarly, the possibility is not excluded of the product or the product flow of the conversion of CO₂ containing, in addition to CO or CO and H₂, as yet unconverted CO₂ and possibly other unconverted gases from the starting material and/or by-products of the conversion—for example depending on the cathode material. According to certain embodiments, however, in addition to possibly unconverted CO₂, the product of the cathode reaction advantageously, substantially contains CO or syngas. For this purpose, the cathode can, for example, comprise a metal selected from Ag, Au, Zn, and/or Pd and compounds and/or alloys thereof.

The anode as well as the anode spaces and the anode reaction are not particularly limited. The anode can be embodied as a full electrode, as a GDE, etc. For example, a reaction of water to oxygen can take place at the anode, for example if an aqueous electrolyte is used in the method.

The electrolyte is not particularly limited, but is advantageously aqueous. The electrolyte can obviously also contain conductive salts, additives for adjusting the pH, etc. These are not particularly limited.

The method according to the invention is characterized by the fact that the electrolyte flow is intercooled between at least two electrolytic cells which are arranged in series one behind the other, for example also between all electrolytic cells which are arranged in series one behind the other. According to embodiments, intercooling takes place at least between two electrolysis cells of different stacks. According to certain embodiments, intercooling takes place between all stacks. Here, the type of intercooling is not particularly limited. For example, the cooling can take place via a heat exchanger and/or via an air cooler.

According to certain embodiments, the at least one electrolyte flow between the multiple electrolytic cells which are arranged in series one behind the other is separated into a catholyte flow and an anolyte flow. This can efficiently prevent mixing of product gases and keep the electrolyte purer as a result of which the efficiency of the electrolysis in the respective electrolytic cell can be improved and also as a result of which the volume flow of electrolyte can be further reduced, as a result of which heating of the electrolyte can be further reduced and thus the efficiency of the cooling improved.

According to certain embodiments, the catholyte flow and the anolyte flow are intercooled between at least two electrolytic cells which are arranged in series one behind the other and can also be intercooled between all electrolytic cells arranged in series one bthind the other. This can reduce or prevent a temperature difference between the catholyte flow and anolyte flow and thus also consequently, because of the possibility of using a small temperature window which is as optimal as possible in terms of efficiency, achieve intensified ion exchange in the electrolyte. According to embodiments, intercooling takes place between stacks in a device according to the invention and in the method according to the invention.

According to certain embodiments, in particular after passing through all the electrolytic cells which are arranged in series one behind the other, the catholyte flow and anolyte flow are combined and recycled in a common electrolyte flow, wherein the common electrolyte flow is optionally degassed and separated into a catholyte flow and an anolyte flow before the first electrolytic cell in the direction of flow. As a result, the catholyte flow and anolyte flow can be rendered uniform again with respect to their concentrations and composition before the start of the next electrolysis cycle, so that the electrolysis can proceed more efficiently.

According to certain embodiments, in at least two of the electrolytic cells which are arranged in series one behind the other, a first and a second starting material flow comprising CO₂ are fed separately, wherein these may or may not follow one another in the direction of flow of an electrolyte. In particular, at least between different stacks of a device in a method according to the invention, advantageously between all stacks of a device in a method according to the invention, possibly even in each of the electrolytic cells which are arranged in series one behind the other, a feed flow comprising CO) is fed separately in order to increase the conversion to CO₂ and reduce the transfer of product gases.

According to certain embodiments, the intercooling is performed by at least one heat exchanger and/or at least one air cooler. These are characterized by high efficiency and permit further use of the waste heat from the electrolysis, which is in particular relevant from a cell size with electrodes of at least 200 cm², advantageously at least 250 cm², in particular at least 300 cm². Here, for example, temperatures of 60° C. and more can arise. In particular, such waste heat can also be used to produce district heating, in particular when heat exchangers are used for the intercooling. Thus, according to certain embodiments, the intercooling is performed by at least one heat exchanger, wherein the waste heat is used as district heating.

In a further aspect, the present invention relates to a device for the electrochemical production of a gas comprising CO, in particular CO or syngas, from CO₂, comprising—multiple electrolytic cells which are arranged one behind the other in particular in the direction of at least one electrolyte flow and each comprise a cathode and an anode; —at least one connecting facility (for the electrolyte or for the electrolyte flow) between at least two electrolytic cells, which is embodied to conduct the at least one electrolyte flow between the at least two electrolytic cells; and—at least one first feed facility for a first starting material flow comprising CO₂, which is embodied to feed the first starting material flow comprising CO₂ to the first electrolysis cell arranged in the direction of flow of the CO₂; further comprising at least one intercooler, which is embodied to cool at least one electrolyte flow of the at least one connecting facility.

As already explained above, the device according to the invention can in particular be used to perform the method according to the invention. In this respect, the embodiment of the electrolytic cells, the at least one connecting facility (for the electrolyte), the at least one first feed facility for a first starting material flow comprising CO₂, and the at least one intercooler can be embodied as already discussed above in connection with the method according to the invention. Here, the embodiment is not particularly limited, however, the corresponding components of the device are advantageously as stated above for the method according to the invention.

The present device can in particular be used to perform the method according to the invention. Accordingly, the present invention is also directed at the use of the device according to the invention in a method for the electrolysis of CO₂, in particular in the method according to the invention. Thus, the statements made above with respect to the method also apply to the present device and accordingly embodiments of the method can be used in the device according to the invention or certain embodiments of the present device can be configured such that the method according to the invention can be performed.

According to certain embodiments, the at least one connecting facility, advantageously each connecting facility (for the electrolyte) between at least two electrolytic cells which are arranged in series one behind the other is provided as at least one first connecting facility and at least one second connecting facility, wherein the at least one first connecting facility is embodied to conduct a catholyte flow and the at least one second connecting facility is embodied to conduct an anolyte flow. Therefore, in such embodiments, the at least one first connecting facility and the at least one second connecting facility are separate, as also explained above, so that the catholyte flow and anolyte flow can in each case be conducted from a cathode space or a anode space of an electrolytic cell to the cathode space or anode space arranged next in series. This enables the composition of the anolyte and catholyte to be retained so that products of the electrolysis that may possibly have been introduced into the respective electrolyte, in particular gas products do not pass into the respective other electrolyte. Thus, in particular if the anolyte and the catholyte are degassed before being combined for recycling, it is, for example, possible to dispense with the cumbersome separation of such gas products with combined e guidance.

According to certain embodiments, at least two intercoolers are provided of which at least one first intercooler is embodied to cool the catholyte flow in the at least one first connecting facility and at least one second intercooler is embodied to cool the anolyte flow in the at least one second connecting facility. Advantageously, intercoolers are provided for all first connecting facilities and second connecting facilities between the electrolytic cells

Obviously, cooling of the electrolyte can also take place after passing through the last electrolytic cell in the direction of flow of the electrolyte, either separately (in the case of an anolyte flow and a catholyte flow) or together for a combined electrolyte flow, so that still at least one cooler can be provided, which is embodied to cool the electrolyte flow after passing through the last electrolytic cell in the direction of flow of the electrolyte.

Thus, in addition to the intercooling between electrolytic cells, i.e. parts of a stack, cooling can also take place between individual stacks or stack modules. Accordingly, also disclosed is an electrolysis system comprising multiple devices according to the invention in the form of stacks. In particular, at least one intercooling between stacks is advantageous.

According to certain embodiments, the device according to the invention further comprises at least one second feed facility for a second starting material comprising CO₂, which is embodied to feed a second starting material flow comprising CO₂ to a further electrolytic cell lying in the direction of flow of the at least one electrolyte flow after the first electrolytic cell in the series. According to certain embodiments, a separate feed facility for a separate starting material flow comprising CO2 is present at least for different stacks of a device according to the invention, advantageously for all stacks of a device according to the invention, possibly even for each electrolytic cell of the device according to the invention, wherein this starting material flow can originate from the same source or different sources.

According to certain embodiments, the cathode is embodied as a gas diffusion electrode in at least one electrolytic cell. According to certain embodiments, the cathode is embodied as a gas diffusion electrode in every electrolytic cell.

According to certain embodiments, the at least one intercooler is embodied as a heat exchanger and/or as air cooler. It is also possible for heat exchangers and/or air coolers to be provided for each connecting facility (for the electrolyte).

According to certain embodiments, the at least one intercooler is embodied as a heat exchanger, wherein the heat exchanger is connected to a district heating network. It is also possible for one or more cooler(s) that may be present after the last electrolytic cell in the direction of flow of the electrolyte, in particular in form of a heat exchanger, to be connected to a district heating network.

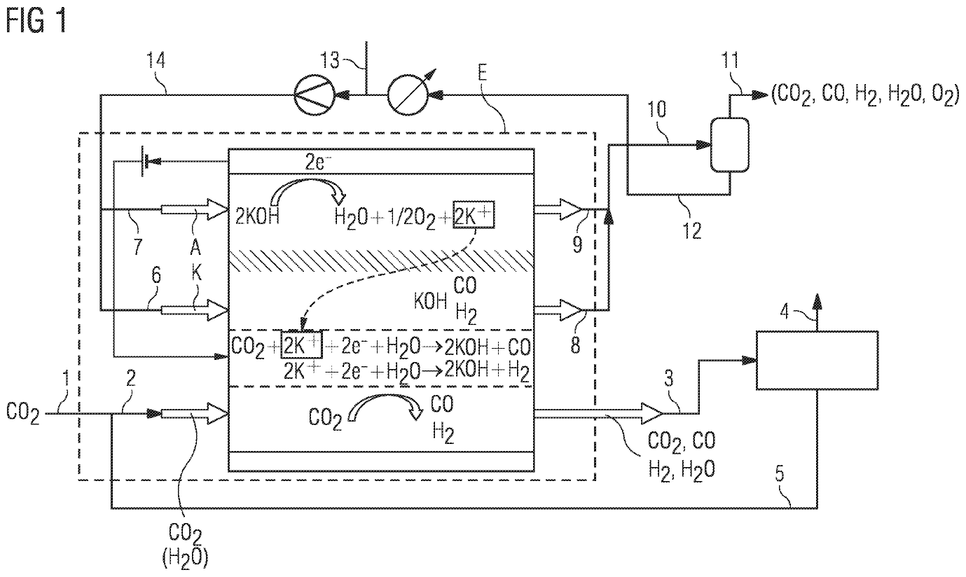

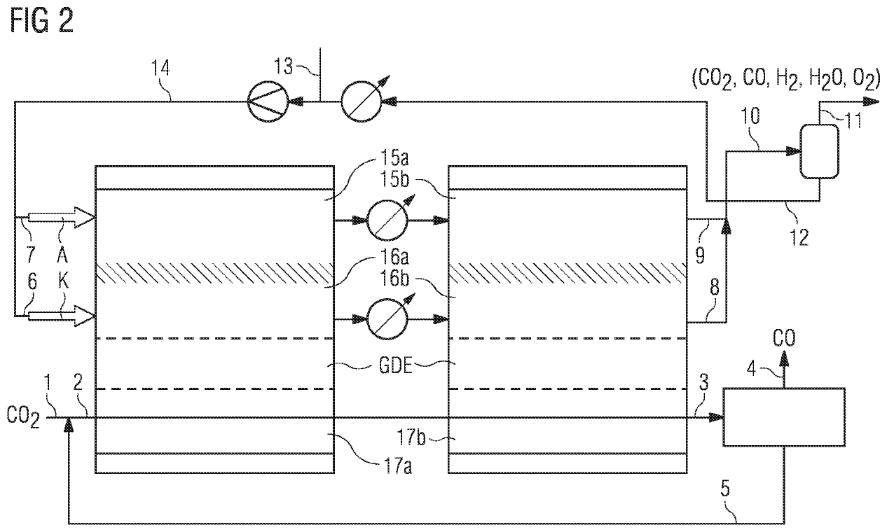

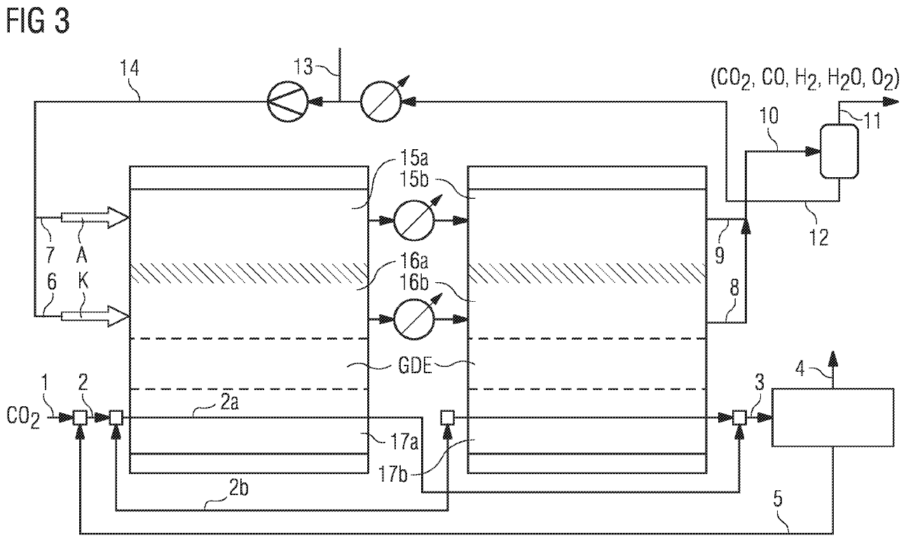

FIGS. 2 and 3 depict exemplary embodiments of the device according to the invention with which the method according to the invention can be performed. Here, the reference numbers in FIGS. 2 and 3 correspond to those FIG. 1, from which it is evident that the devices to some extent have the same design.

While, for better clarity and for better and easier understanding of the invention, FIGS. 2 and 3 in each case depict by way of example two electrolytic cells arranged one behind the other, the invention is not limited to two electrolytic cells arranged one behind the other.

In contrast to the device in FIG. 1, FIG. 2 depicts intercooling of the electrolyte with a common gas channel 17a, 17b for the starting material comprising CO₂ for the individual cells, as in FIG. 1. In contrast to FIG. 1, this electrolytic cell E is separated into two regions, wherein the volume for the through-flow of starting material and electrolyte in the electrolytic cells does not change. However, the anolyte space is separated into the anolyte channels 15a, 15b and the catholyte room into the catholyte channels 16a, 16b. As in FIG. 1, the actual cathode is again embodied as a gas diffusion electrode GDE, wherein—like the anode—this is now “divided into two”. In each case, intercooling is provided between the anolyte channel 15a and the anolyte channel 15b and the catholyte channel 16a and the catholyte channel 16b. This intercooling can approximately halve the amount of electrolyte circulating in the device with the same dissipation of heat from the electrolysis if necessary. In the case of multiple intercooling stages, the amount of electrolyte recycled can be further reduced. Moreover, this can reduce the gas losses in the gas flow 11. The effect with respect to gas losses with different electrolysis operating pressures is further elucidated in Table 1 of inventive example 1. Herein, the gas losses are proportional to the amount of electrolyte circulated.

FIG. 3 depicts intercooling of the electrolyte with a separate gas channel 17a, 17b as a further exemplary embodiment of the device according to the invention. This design is particularly simple to produce. Herein, the setup to a large extent corresponds to that in FIG. 2, wherein however, before the first cell in the direction of flow of the starting material comprising CO₂, the CO₂ feed 2 is separated into a first feed facility for starting material comprising CO₂ 2a and a second feed facility for starting material comprising CO₂ 2b.

The figures depicted only represent the basic concept of the invention, wherein other types of interconnection are also possible. The essential factor is cooling of the liquid electrolyte between multiple electrolytic cells in a stack and/or between different stacks as intercooling, wherein the electrolyte is conducted sequentially through the electrolytic cells or the stack or the stacks. Therefore, the figures should not be understood to be restrictive.

With regard to material savings, it is advantageous according to certain embodiments, to divide the stack, i.e. multiple electrolytic cells, in the device according to the invention into individual blocks, for example 10-200, advantageously 25-100 cells. In each case, intercooling can also take place between the blocks. In particular intercooling takes place between the blocks.

The above embodiments, configurations and developments may, where advisable be combined with one another as desired. Further possible configurations, developments and implementations of the invention also include combinations of features of the invention described above or below with reference to the exemplary embodiments that are not explicitly named. In particular, the person skilled in the art will also add individual aspects as improvements or additions to the respective basic form of the present invention.

The invention is explained in further detail below with reference to different examples. However, the invention is not restricted to these examples.

### Example 1

A device according to the invention with two electrolytic cells was provided in accordance with the setup in FIG. 3, wherein in each case a heat exchanger was provided on the connecting facility between the anolyte channels 15a, 15b and between the catholyte channels 16a, 16b. Table 1 shows by way of example gas losses and CO₂ consumption in electrochemical production of CO for different electrolyte temperatures and flow rates. Here, the temperature can be adjusted via the inlet temperature of the electrolyte, an aqueous electrolyte comprising a conductive salt, before the first electrolytic cell. Herein, the cathodes of the individual electrolytic cells were Ag cathodes and their anodes were iridium-containing anodes on which oxygen formed. The starting material gas used was pure CO₂, wherein carbon dioxide with a total of up to 25 vol % CO and/or H₂ would also have been suitable as a starting material gas.

TABLE 1
Effect of one-stage intercooling on the composition of the O₂ waste gas
flow assuming that the gases under consideration physically dissolve in
the electrolyte and the respective equilibria have been established.

| | Temperature | Gas outlet | Specific consumption |
|---|---|---|---|
| Pressure [bar] | [° C.] | (H₂/CO/CO₂) [mol %]* | of CO₂ [Nm³_{CO2/}Nm³_{CO}] |
| 2 (without intercooling] | 35 | 0/0.3/13 | 1.3 |
| 2 (without intercooling] | 60 | 0/0.2/8 | 1.3 |
| 20 (without intercooling] | 35 | 0.3/3/42 | 1.7 |
| 20 (without intercooling] | 60 | 0.3/2/36 | 1.6 |
| 2 (with intercooling]** | 35 | 0/0.2/7 | 1.3 |
| 2 (with intercooling]** | 60 | 0/0.1/4 | 1.3 |
| 20 (with intercooling]** | 35 | 0.2/2/21 | 1.5 |
| 20 (with intercooling]** | 60 | 0.2/1/18 | 1.4 |

*Residue (mol %; based on gas at the outlet): substantially O₂
**Intercooling such that the temperature shown is reached at the cell inlet or stack inlet of the cell adjoining the intercooling.

As evident from Table 1, the gas losses can be reduced by intercooling.

In the example, the flows are shown by way of example without and with intercooling. However, the invention can also be applied with any other order of magnitude. The composition of the individual flows varies in dependence on the CO₂ conversion in the electrolysis and the formation of hydrogen and other secondary components. Gas losses can be further reduced with multiple intercooling stages.

The invention can obviously also be applied to the common production of H₂ and CO (syngas), for example in LT co-electrolysis. A high electrolysis pressure is also advantageous for the separation of the unconverted CO₂ with a method of this kind and there is a similar solubility problem. Here, the reduction of the electrolyte circuit flow also reduces gas loss.

The invention can obviously also be used if the electrolytes are not mixed or only partially mixed.

1. A method for electrochemical production of a gas comprising CO from CO₂, wherein the electrochemical production of the gas comprising CO from CO₂ takes place in multiple electrolytic cells which are arranged in series one behind the other in a direction of at least one electrolyte flow and each comprise a cathode and an anode, the method comprising:
conducting the at least one electrolyte flow through the electrolytic cells which are arranged in series one behind the other; and
intercooling the at least one electrolyte flow between at least two electrolytic cells which are arranged in series one behind the other.

2. The method as claimed in claim 1,
wherein the at least one electrolyte flow between the multiple electrolytic cells which are arranged in series one behind the other is separated into a catholyte flow and an anolyte flow.

3. The method as claimed in claim 2,
wherein the catholyte flow and the anolyte flow are intercooled between at least two electrolytic cells which are arranged in series one behind the other.

4. The method as claimed in claim 3,
wherein the catholyte flow and anolyte flow are combined and recycled in a common electrolyte flow, wherein the common electrolyte flow is optionally degassed and separated before a first electrolytic cell in the direction of flow into a catholyte flow and an anolyte flow.

5. The method as claimed in claim 1,
wherein, in at least two of the electrolytic cells which are arranged in series one behind the other, a first and a second starting material flow comprising CO₂ are fed separately.

6. The method as claimed in claim 1,
wherein, in at least one electrolytic cell, the cathode is embodied as a gas diffusion electrode.

7. The method as claimed in claim 1,
wherein the intercooling is performed by at least one heat exchanger and/or at least one air cooler.

8. The method as claimed in claim 7,
wherein the intercooling is performed by at least one heat exchanger, wherein waste heat is used as district heating.

9. A device for electrochemical production of a gas comprising CO from CO₂, comprising:
multiple electrolytic cells which are arranged one behind the other in a direction of at least one electrolyte flow and each comprise a cathode and an anode;
at least one connecting facility between at least two electrolytic cells, which is embodied to conduct the at least one electrolyte flow between the at least two electrolytic cells;
at least one first feed facility for a first starting material flow comprising CO₂, which is embodied to feed the first starting material comprising CO₂ to a first electrolytic cell arranged in the direction of flow of the CO₂; and
at least one intercooler, which is embodied to cool at least one electrolyte flow of the at least one connecting facility.

10. The device as claimed in claim 9,
wherein the at least one connecting facility is provided between at least two electrolytic cells which are arranged in series one behind the other as at least one first connecting facility and at least one second connecting facility, wherein the at least one first connecting facility is embodied to conduct a catholyte flow and the at least one second connecting facility is embodied to conduct an anolyte flow.

11. The device as claimed in claim 10,
wherein at least two intercoolers are provided of which at least one first intercooler is embodied to cool the catholyte flow in the at least one first connecting facility and at least one second intercooler is embodied to cool the anolyte flow in the at least one second connecting facility.

12. The device as claimed in claim 9, further comprising:
at least one second feed facility for a second starting material flow comprising CO₂, which is embodied to feed a second starting material flow comprising CO₂ to a further electrolytic cell lying in the direction of flow of the at least one electrolyte flow after the first electrolytic cell in the series.

13. The device as claimed in claim 9,
wherein, in at least one electrolytic cell, the cathode is embodied as a gas diffusion electrode.

14. The device as claimed in claim 9,
wherein the at least one intercooler is embodied as a heat exchanger and/or as an air cooler.

15. The device as claimed in claim 14,
wherein the at least one intercooler is embodied as a heat exchanger, wherein the heat exchanger is connected to a district heating network.
